(19) United States
(12) Patent Application Publication
(10) Pub. No.: US 2009/0288815 A1
(43) Pub. Date: Nov. 26, 2009

(54) Heat-dissipating device without injection pipe and method of making the same

(76) Inventor: Chi-Te Chin, Taichung City (TW)

Correspondence Address: BACON & THOMAS, PLLC, 625 SLATERS LANE, FOURTH FLOOR, ALEXANDRIA, VA, 22314-1176, US

(21) Appl. No.: 12/453,849

(22) Filed: May 26, 2009

(30) Foreign Application Priority Data
May 26, 2008 (TW) 97119445

(51) Int. Cl. F28F 3/00; B23K 26/20

(52) U.S. Cl. 165/185; 219/121.64

(57) ABSTRACT

A heat-dissipating device without any injection pipe, which includes an upper cover plate and a lower cover plate. The upper cover plate is combined with the lower cover plate, wherein a crevice and an internal space are formed between the upper and lower cover plates. The crevice is sealed by where the upper and lower cover plates are close to the crevice by high-temperature autogenous welding to become a flat sealed surface flush with the surfaces of the upper and lower cover plates. Accordingly, the heat-dissipating device is provided with enhanced reliability and heat-dissipating efficiency. A method of making the heat-dissipating device includes the steps of putting the upper and lower cover plates together by welding; injecting a liquid working medium through the crevice into the internal space; and sealing the crevice by high-speed welding under a vacuum environment.

### BACKGROUND OF THE INVENTION

1. Field of the Invention

The present invention relates generally to heat-dissipating technology, and more particularly, to a heat-dissipating device without any injection pipe and a method of making the same.

2. Description of the Related Art

As the electronic products gradually tends to be high-level, light and thin, and multi-functional, their electronic components must have more powerful functions and higher requirement for thermal dissipation to increase their longevity, reliability, and stability. The heat-dissipating system is very crucial to keeping the electronic chips under normal working temperature. After the chips are designed and packaged, their thermal reliability depends on the heat-dissipating efficiency of the heat-dissipating system.

The current products to which the light emitting diode (LED) is applied are very broad in scope, such as backlight sources of control panels of audios, backlight sources of keypads of mobile phones, or backlight sources of screens of mobile phones. However, the LEDs have been aggressively improved for more brightness in the industry, such that each LED needs more power consumption and radiates more heat. Under the circumstances, the current products whose luminous sources are based on the LEDs are all facing the problem of thermal dissipation, thus restricting the development of the size of the products that the LED is applied to.

In light of the above disadvantages, flat heat pipe, vapor chamber, and loop heat pipe have been proposed and are deemed to highly possibly become the next-generation dominant heat-dissipating element for the electronic components. However, they have not been extensively applied yet because the process of making them in mass production still needs improvement for thickness, smoothness, internal structure, shape, etc. and the customers' different requirements may come up with various assembly structures. Besides, the effective reduction of the production cost also becomes a bottleneck and the internal circulation loop of working fluid is circuitous, such that there are more unsure factors for the stability and reliability of the flat heat-dissipating device and the loop heat pipe.

The conventional heat-dissipating device is based on the principle of inner working medium liquid phase transition for thermal dissipation, like the flat heat pipe, the loop heat pipe, and the vapor chamber. Each of the flat heat pipe and the vapor chamber is a closed vacuum container containing a liquid working medium. The loop heat pipe is a two-phase high-efficient heat-dissipating device functioning like that its capillary wick inside the evaporator is based on the capillary force to drive the steam loop, and then the heat is transmitted by means of evaporation and condensation of the liquid working medium, such that it can transmit a great amount of heat under the conditions of small temperature difference and long distance.

The current popular method of making the heat-dissipating device includes the steps of welding the periphery of the heat-dissipating device and then drilling a hole, welding a tube, injecting a liquid in vacuum, sealing the hole, and finally end-welding. The drilling step can be skipped by forming the hole beforehand while stamping mold of upper and lower plates of the device. However, such method usually brings about an injection tube of 0.5-3 cm left and exposed outside after the production, such that it is not easy to control the production process and the thermal dissipation is subject to inefficiency. Besides, the exposed injection tube easily becomes where the stresses converge and thus vulnerable, such that it is not reliable and subject to rupture resulted from an external collision.

### SUMMARY OF THE INVENTION

The primary objective of the present invention is to provide a heat-dissipating device without any injection pipe, where a liquid working medium is filled with a flat sealed surface and whose reliability and thermal dissipation are preferable.

The secondary objective of the present invention is to provide a method of making the aforesaid heat-dissipating device, which can simplify the mass-production process.

The primary objective of the present invention is attained by the heat-dissipating device composed of an upper cover plate and a lower cover plate. The upper cover plate is butted with the lower cover plate, whereby a crevice and an internal space are formed between the upper and lower cover plates. A liquid working medium is filled in the internal space. The crevice is sealed by where the upper and lower cover plates are close to the crevice by high-temperature autogenous welding to become a flat sealed surface flush with the surfaces of the upper and lower cover plates.

The secondary objective of the present invention is attained by the method including the steps of preparing an upper cover plate and a lower cover plate; putting the upper and lower cover plates together by welding to define a crevice and an internal space between the two cover plates; injecting a liquid working medium through the crevice into the internal space; and sealing the crevice by welding under a vacuum environment.

### BRIEF DESCRIPTION OF THE DRAWINGS

FIG. 1 is a perspective view of a first preferred embodiment of the present invention.

FIG. 2 is a side view of the first preferred embodiment of the present invention.

FIG. 3 is a flow diagram of a second preferred embodiment of the present invention.

### DETAILED DESCRIPTION OF PREFERRED EMBODIMENTS

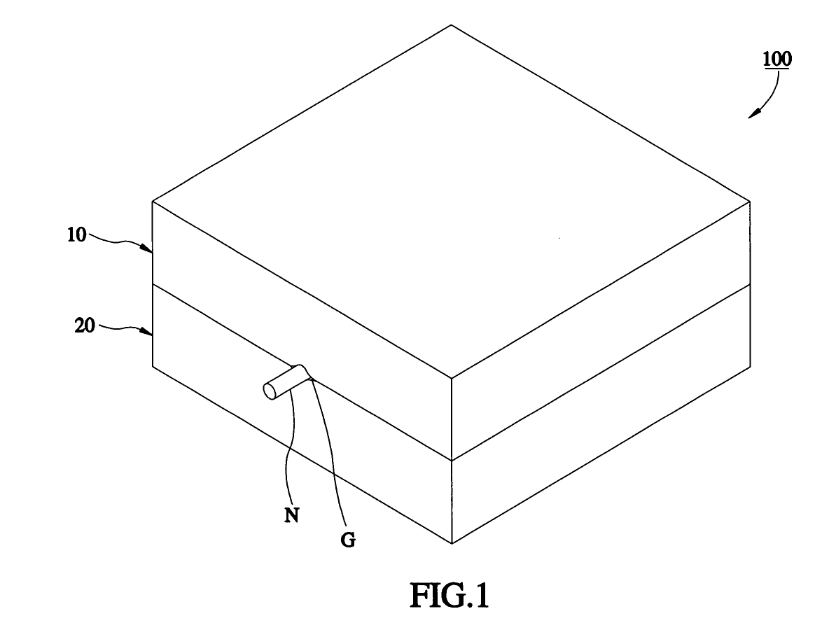

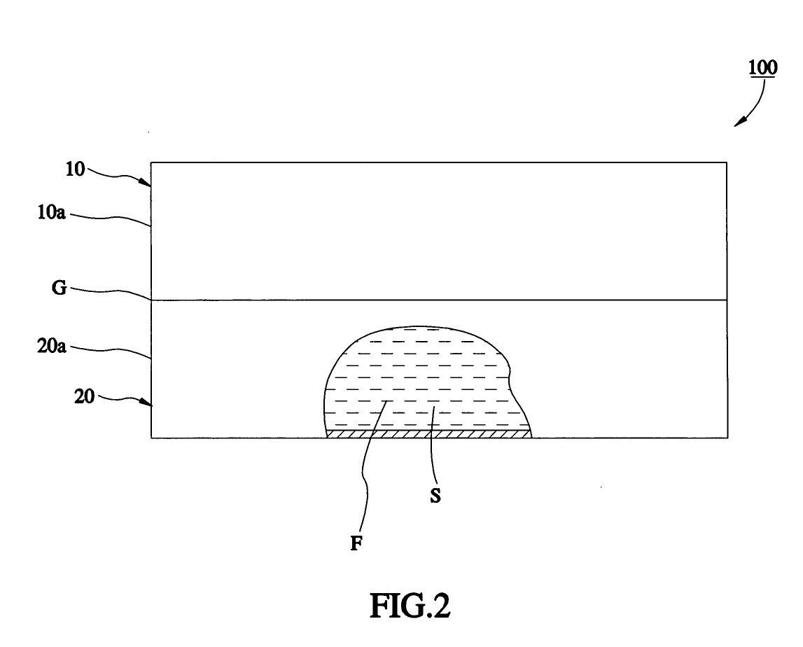

Referring to FIGS. 1-2, a heat-dissipating device 100 without any injection pipe in accordance with a first preferred embodiment of the present invention is composed of an upper cover plate 10 and a lower cover plate 20. The upper cover plate 10 is put together with the lower cover plate 20 by welding. After the welding, an internal space S is formed between the upper and lower cover plates 10 and 20 and a crevice G is formed through the upper and lower cover plates 10 and 20 beforehand for communication with the internal space S and outside. Next, a fine needle tube N is inserted into the crevice G and then a liquid working medium F is injected through the fine needle tube N into the internal space S, such that the liquid working medium F is filled in the internal space S. Then, the upper and lower cover plates 10 and 20 are held by a jig (not shown) and put into a vacuum environment, and finally the crevice G is quickly sealed by high-energy welding preferably. In this embodiment, the high-energy welding indicates high-frequency argon-arc welding, electron-beam welding or laser welding. The rapid high-energy welding is different from the general welding that will generate high temperature in a relatively large region to soften and oxidize the upper and lower cover plates 10 and 20 and affect the liquid working medium F. The rapid high-energy welding applied to the present invention can enable a part located at where the upper and lower cover plates 10 and 20 are close to the crevice G to seal the crevice G by the high-temperature autogenous welding. As shown in FIG. 2, the crevice G becomes a flat sealed surface flush with surfaces 10a and 20a of the upper and lower cover plates and does not affect the liquid working medium F.

As can seen from above, the method of making the heat-dissipating device 100 skips the conventional steps of welding tube and sealing hole, thus simplifying the process of mass production. Besides, where the liquid working medium F is filled in the heat-dissipating device 100, i.e. the crevice G, is formed to become the flat sealed surface flush with the surfaces of the upper and lower cover plates 10 and 20. Compared with the conventional devices mentioned above, the heat-dissipating device 100 of the present invention is much more reliable and thermally dissipative.

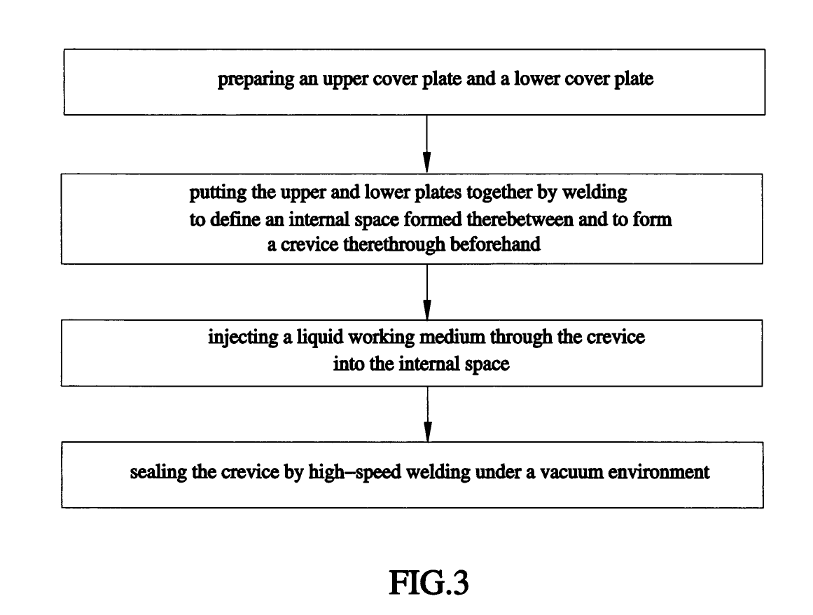

Referring to FIG. 3, a method of making the above-mentioned heat-dissipating device 100 includes the following steps.

a) preparing the upper cover plate 10 and the lower cover plate 20;

b) putting the upper and lower cover plates 10 and 20 together by welding to define an internal space S formed therebetween and to form a crevice G therethrough beforehand;

c) injecting the liquid working medium F through the crevice G into the internal space S; and

d) sealing the crevice G by high-speed welding under a vacuum environment.

Although the present invention has been described with respect to specific preferred embodiments thereof, it is no way limited to the details of the illustrated structures but changes and modifications may be made within the scope of the appended claims.

What the invention claimed is:

1. A method of making a heat-dissipating device without any injection tube, comprising steps of:
a) preparing an upper cover plate and a lower cover plate;
b) putting the upper and lower cover plates together by welding to define an internal space formed therebetween and to form a crevice therethrough beforehand;
c) injecting a liquid working medium through the crevice into the internal space; and
d) sealing the crevice by high-speed welding under a vacuum environment.

2. The method as defined in claim 1, wherein in the step c), a fine needle tube is inserted into the crevice and then the liquid working medium is injected through the fine needle tube into the internal space.

3. The method as defined in claim 1, wherein a step of holding the upper and lower cover plates is included between the steps c) and d).

4. The method as defined in claim 1, wherein the crevice in the step d) is sealed by high-energy welding.

5. The method as defined in claim 4, wherein the crevice in the step d) is sealed by high-frequency argon-arc welding.

6. The method as defined in claim 4, wherein the crevice in the step d) is sealed by electron-beam welding.

7. The method as defined in claim 4, wherein the crevice in the step d) is sealed by laser welding.

8. A heat-dissipating device without any injection tube manufactured by the process of claim 1, comprising an upper cover plate and a lower cover plate combined with the upper cover plate; wherein an internal space and a crevice are formed between the upper and lower cover plates, a liquid working medium is filled in the internal space, and where the upper and lower cover plates are close to the crevice seals the crevice by high-temperature autogenous welding, whereby the crevice becomes a flat sealed surface flush with surfaces of the upper and lower cover plates.
